(19) United States
(12) Patent Application Publication
(10) Pub. No.: US 2017/0208154 A1
(43) Pub. Date: Jul. 20, 2017

(54) METHOD FOR TRANSMITTING AND RECEIVING PHYSICAL PROTOCOL DATA UNIT IN A WIRELESS LOCAL AREA NETWORK AND DEVICE FOR SAME

(71) Applicant: LG ELECTRONICS INC., Seoul (KR)

(72) Inventors: Sungjin PARK, Seoul (KR); Hangyu CHO, Seoul (KR); Kyungtae JO, Seoul (KR); Jinmin KIM, Seoul (KR)

(73) Assignee: LG ELECTRONICS INC., Seoul (KR)

(21) Appl. No.: 15/406,632

(22) Filed: Jan. 13, 2017

Related U.S. Application Data
(60) Provisional application No. 62/278,357, filed on Jan. 13, 2016.
(60) Provisional application No. 62/278,446, filed on Jan. 14, 2016.

(51) Int. Cl. H04L 29/06; H04L 29/08; H04L 29/12

(52) U.S. Cl. CPC H04L 69/22; H04L 61/6022; H04L 69/324; H04W 84/12

(57) ABSTRACT

An operation configuration of a station or an access point in a WLAN system is disclosed. In more detail, a method for transmitting and receiving a physical protocol data unit (PPDU) to and from a station or access point in a WLAN system and a device for the same are disclosed.

### BACKGROUND OF THE INVENTION

Field of the Invention

The present invention relates to an operation configuration of a station or an access point in a WLAN system, and more particularly, to a method for transmitting and receiving a physical protocol data unit (PPDU) to and from a station or access point in a WLAN system and a device for the same.

Discussion of the Related Art

Standards for the WLAN technology have been developed as Institute of Electrical and Electronics Engineers (IEEE) 802.11 standards. IEEE 802.11a and b use an unlicensed band at 2.4 GHz or 5 GHz. IEEE 802.11b provides a transmission rate of 11 Mbps and IEEE 802.11a provides a transmission rate of 54 Mbps. IEEE 802.11g provides a transmission rate of 54 Mbps by applying Orthogonal Frequency Division Multiplexing (OFDM) at 2.4 GHz. IEEE 802.11n provides a transmission rate of 300 Mbps for four spatial streams by applying Multiple Input Multiple Output (MIMO)-OFDM. IEEE 802.11n supports a channel bandwidth of up to 40 MHz and, in this case, provides a transmission rate of 600 Mbps.

The above-described WLAN standards have evolved into IEEE 802.11ac that uses a bandwidth of up to 160 MHz and supports a transmission rate of up to 1 Gbits/s for 8 spatial streams and IEEE 802.11ax standards are under discussion.

Meanwhile, IEEE 802.11ad defines performance enhancement for high-speed throughput in the 60 GHz band, and IEEE 802.11ay, for introducing channel bonding and MIMO technology to IEEE 802.11ad systems for the first time, is being discussed.

### SUMMARY OF THE INVENTION

Accordingly, the present invention is directed to a method for transmitting and receiving a PPDU applicable to various Wi-Fi systems (e.g., IEEE 802.11n, 802.11ac, 802.11ax, etc.) including IEEE 802.11ay.

Particularly, an object of the present invention is to provide a new encoding method to transmit the PPDU.

Additional advantages, objects, and features of the specification will be set forth in part in the description which follows and in part will become apparent to those having ordinary skill in the art upon examination of the following or may be learned from practice of the specification. The objectives and other advantages of the specification may be realized and attained by the structure particularly pointed out in the written description and claims hereof as well as the appended drawings.

To achieve these objects and other advantages and in accordance with the purpose of the specification, as embodied and broadly described herein, a method for transmitting a physical protocol data unit (PPDU) from a station (STA) in a wireless LAN (WLAN) system comprises the steps of encoding first payload information included in a payload together with enhanced directional multi-gigabit (EDMG) header information in one encoding unit; and transmitting the PPDU that includes the EDMG header information and the first payload information, which are encoded together.

In another aspect of the present invention, a method for receiving a physical protocol data unit (PPDU) in a station (STA) in a wireless LAN (WLAN) system comprises the steps of receiving the PPDU in which first payload information included in a payload is encoded together with enhanced directional multi-gigabit (EDMG) header information in one encoding unit; and decoding the EDMG header information and the first payload information together, which are encoded.

In still another aspect of the present invention, a station operated in a WLAN system comprises a transceiving module having one or more radio frequency (RF) chains, configured to transmit and receive a signal to and from another station; and a processor connected with the transceiving module, processing the signal transmitted and received by the transceiving module, wherein the processor is configured to encode first payload information included in a payload together with enhanced directional multi-gigabit (EDMG) header information in one encoding unit and transmit a PPDU that includes the EDMG header information and the first payload information, which are encoded together.

In further still another aspect of the present invention, a station operated in a WLAN system comprises a transceiving module having one or more radio frequency (RF) chains, configured to transmit and receive a signal to and from another station; and a processor connected with the transceiving module, processing the signal transmitted and received by the transceiving module, wherein the processor is configured to receive a PPDU in which first payload information included in a payload is encoded together with enhanced directional multi-gigabit (EDMG) header information in one encoding unit and decode the EDMG header information and the first payload information together, which are encoded.

In this case, the first payload information may be a part of the payload.

Also, the first payload and EDMG header information may be encoded by a low density parity check (LDPC) encoding method.

Also, the first payload information may comprise one or more of physical access control (MAC) header information on the payload, MAC header information and data information on the payload, multicast information, and broadcast information.

Also, the first payload information may include cyclic redundancy check (CRC) bits.

Also, when the PPDU is transmitted in multi-streams, the first payload information per stream is identical.

According to the present invention, it is advantageous that partial information of the EDMG Header information and the payload is encoded in one encoding unit to enable more compact PPDU transmission.

Also, since the partial information of the payload information is transmitted previously, signal processing for obtaining the other payload information may be performed quickly.

The effects that may be obtained by the present invention are not limited to the above-mentioned effects, and other effects not mentioned above will be clearly understood by those skilled in the art from the following description.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating an exemplary configuration of a Wireless Local Area Network (WLAN) system;

FIG. 2 is a diagram illustrating another exemplary configuration of a WLAN system;

FIG. 3 is a diagram illustrating a channel in a 60 GHz band for explaining a channel bonding operation according to an embodiment of the present invention;

FIG. 4 illustrates a basic method of performing channel bonding in a WLAN system;

FIG. 5 is a diagram illustrating configuration of a beacon interval;

FIG. 6 is a diagram illustrating a physical configuration of an existing radio frame;

FIGS. 7 and 8 are diagrams illustrating configuration of the header field of the radio frame of FIG. 6;

FIG. 9 is a diagram showing a PPDU structure applicable to the present invention;

FIG. 10 is a diagram illustrating a PPDU structure applicable to the present invention;

FIG. 11 is a diagram illustrating a PPDU structure applicable to the present invention in case of non-channel bonding;

FIG. 12 is a diagram illustrating a PPDU structure applicable to the present invention in case of channel bonding;

FIG. 13 is a diagram illustrating a PPDU structure applicable to the present invention in case of multi-stream transmission;

FIG. 14 is a diagram illustrating a PPDU structure applicable to the present invention;

FIG. 15 is a diagram illustrating a symbol #2 PPDU of a PPDU format A or a symbol #3 of a PPDU format B, which is shown in FIG. 14; and

FIG. 16 is a diagram illustrating a device for implementing the above-described method.

### DETAILED DESCRIPTION OF THE PREFERRED EMBODIMENTS

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention.

The following detailed description includes specific details in order to provide a thorough understanding of the present invention. However, it will be apparent to those skilled in the art that the present invention may be practiced without such specific details. In some instances, known structures and devices are omitted or are shown in block diagram form, focusing on important features of the structures and devices, so as not to obscure the concept of the present invention.

As described above, a detailed description will be given of the introduction of the concept of a downlink oriented channel, and a method and apparatus for conducting communication using a downlink oriented channel in a high-density Wireless Local Area Network (WLAN) system.

1. Wireless LAN (WLAN) System

1-1. Generals of WLAN system

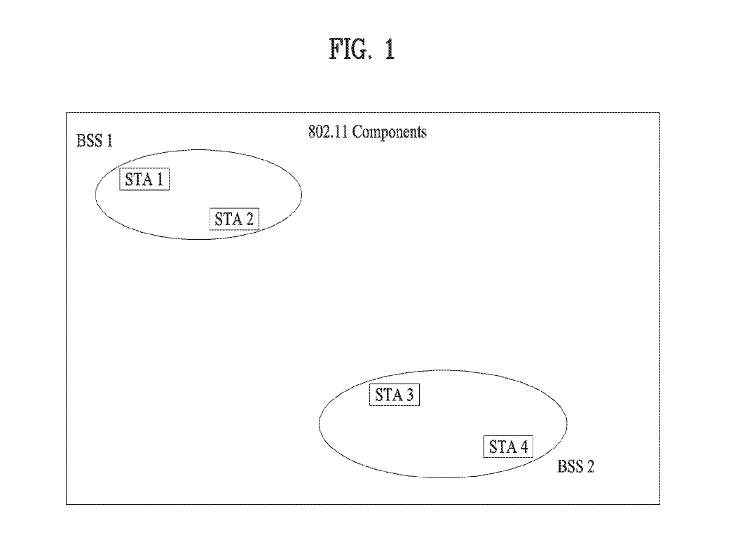

FIG. 1 is a diagram illustrating an exemplary configuration of a WLAN system.

As illustrated in FIG. 1, the WLAN system includes at least one Basic Service Set (BSS). The BSS is a set of STAs that are able to communicate with each other by successfully performing synchronization.

An STA is a logical entity including a physical layer interface between a Medium Access Control (MAC) layer and a wireless medium. The STA may include an AP and a non-AP STA. Among STAs, a portable terminal manipulated by a user is the non-AP STA. If a terminal is simply called an STA, the STA refers to the non-AP STA. The non-AP STA may also be referred to as a terminal, a Wireless Transmit/Receive Unit (WTRU), a User Equipment (UE), a Mobile Station (MS), a mobile terminal, or a mobile subscriber unit.

The AP is an entity that provides access to a Distribution System (DS) to an associated STA through a wireless medium. The AP may also be referred to as a centralized controller, a Base Station (BS), a Node-B, a Base Transceiver System (BTS), or a site controller.

The BSS may be divided into an infrastructure BSS and an Independent BSS (IBSS).

The BSS illustrated in FIG. 1 is the IBSS. The IBSS refers to a BSS that does not include an AP. Since the IBSS does not include the AP, the IBSS is not allowed to access to the DS and thus forms a self-contained network.

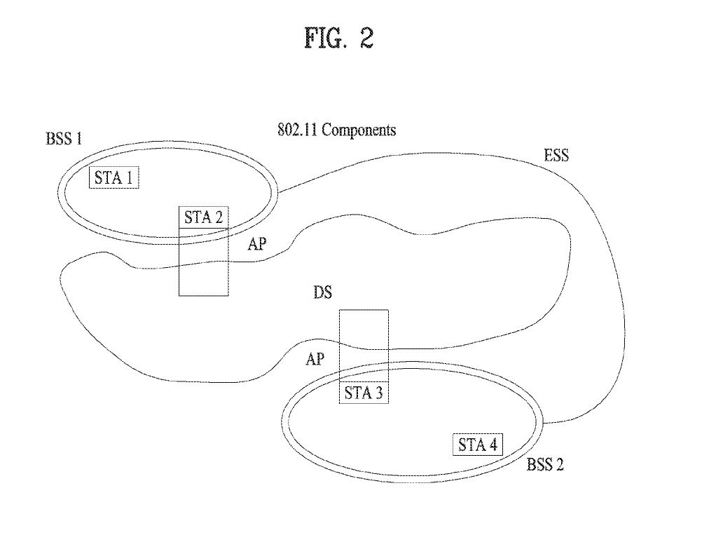

FIG. 2 is a diagram illustrating another exemplary configuration of a WLAN system.

BSSs illustrated in FIG. 2 are infrastructure BSSs. Each infrastructure BSS includes one or more STAs and one or more APs. In the infrastructure BSS, communication between non-AP STAs is basically conducted via an AP. However, if a direct link is established between the non-AP STAs, direct communication between the non-AP STAs may be performed.

As illustrated in FIG. 2, the multiple infrastructure BSSs may be interconnected via a DS. The BSSs interconnected via the DS are called an Extended Service Set (ESS). STAs included in the ESS may communicate with each other and a non-AP STA within the same ESS may move from one BSS to another BSS while seamlessly performing communication.

The DS is a mechanism that connects a plurality of APs to one another. The DS is not necessarily a network. As long as it provides a distribution service, the DS is not limited to any specific form. For example, the DS may be a wireless network such as a mesh network or may be a physical structure that connects APs to one another.

Based on the above, a method of channel bonding in the WLAN system will be described.

1-2 Channel Bonding in WLAN System

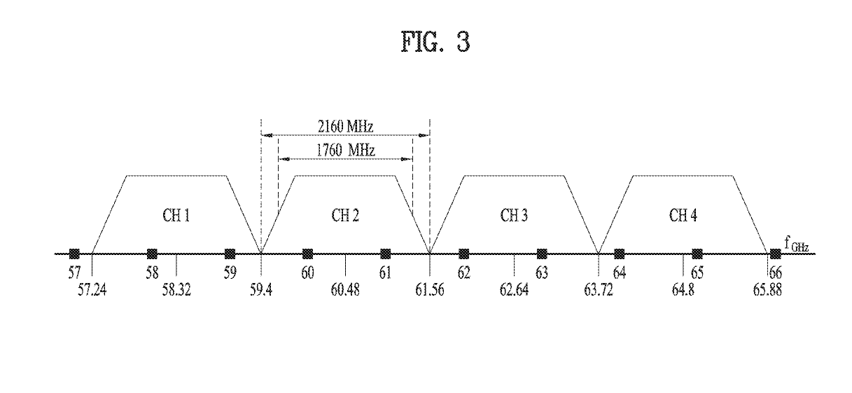

FIG. 3 is a diagram illustrating a channel in a 60 GHz band for explaining a channel bonding operation according to an embodiment of the present invention.

As shown in FIG. 3, four channels may be configured in the 60 GHz band, and the typical channel bandwidth may be 2.16 GHz. The ISM band (57 GHz to 66 GHz) available at 60 GHz may be specified differently for different countries. In general, channel 2 of the channels shown in FIG. 3 is available in all regions and may be used as a default channel. Most of the regions, except Australia, may use channels 2 and 3, which may be utilized for channel bonding. However, the channels used for channel bonding may vary, and the present invention is not limited to a specific channel

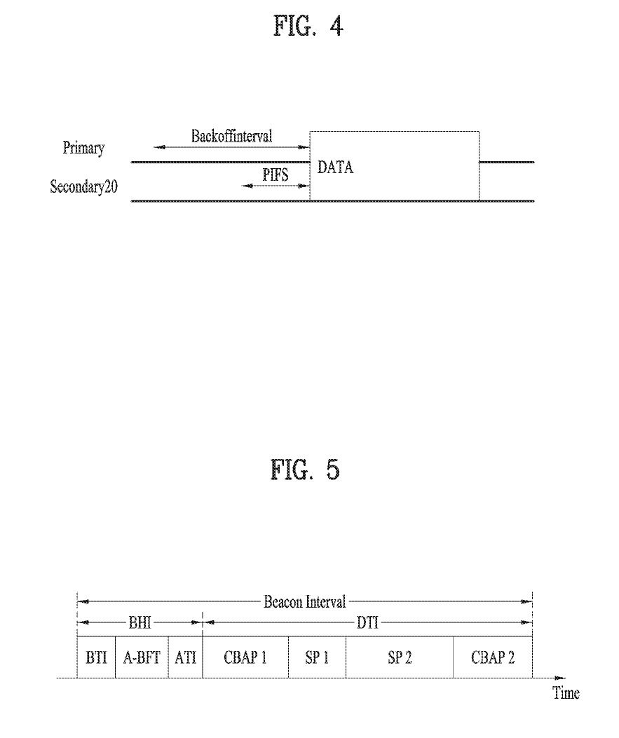

FIG. 4 illustrates a basic method of performing channel bonding in a WLAN system.

The example of FIG. 4 illustrates the operation of 40 MHz channel bonding performed by combining two 20 MHz channels in the IEEE 802.11n system. For IEEE 802.11ac, 40/80/160 MHz channel bonding may be performed.

The two channels exemplarily shown in FIG. 4 include a primary channel and a secondary channel, and the STA may review the channel status of the primary channel of the two channels in the CSMA/CA manner. If the secondary channel is idle for a predetermined time (e.g., PIFS) while the primary channel is idle during a certain backoff interval and the backoff count becomes 0, the STA may transmit data by bonding the primary channel and the secondary channel

In the case where channel bonding is performed based on contention as shown in FIG. 4, channel bonding is allowed only when the secondary channel remains idle for a predetermined time at the time when the backoff count for the primary channel expires, and therefore the application of channel bonding is very limited, and it is difficult to flexibly cope with the media situation.

Accordingly, in one aspect of the present invention, an AP may transmit scheduling information to STAs to perform access based on scheduling. Meanwhile, in another aspect of the present invention, channel access may be performed based on the above-described scheduling or on contention independently of the above-described scheduling. In yet another aspect of the present invention, communication may be performed based on beamforming using a spatial sharing technique.

1-3. Beacon Interval Configuration

FIG. 5 is a diagram illustrating configuration of a beacon interval.

In 11ad-based DMG BSS systems, the media time may be divided into beacon intervals. The sub-intervals within a beacon interval may be referred to as access periods. Different access intervals within one beacon interval may have different access rules. The information on the access intervals may be transmitted to a non-AP STA or a non-PCP by the AP or Personal Basic Service Set Control Point (PCP).

As shown in FIG. 5, one beacon interval may include one beacon header interval (BHI) and one data transfer interval (DTI). The BHI may include a beacon transmission interval (BTI), an association beamforming training (A-BFT) interval, and an announcement transmission interval (ATI) as shown in FIG. 4.

The BTI refers to an interval during which one or more DMG beacon frames may be transmitted. The A-BFT interval refers to an interval during which beamforming training is performed by an STA that has transmitted the DMG beacon frame during the preceding BTI. The ATI refers to a request-response-based management access interval between a PCP/AP and a non-PCP/non-AP STA.

Meanwhile, the data transfer interval (DTI) is an interval during which frame exchange is performed between STAs, and may be allocated one or more Contention Based Access Periods (CBAPs) and one or more service periods (SPs) as shown in FIG. 5. Although FIG. 5 illustrates an example of allocation of two CBAPs and two SPs, this is illustrative and not restrictive.

Hereinafter, the physical layer configuration in a WLAN system to which the present invention is applied will be described in detail.

1-4. Physical Layer Configuration

It is assumed that the following three different modulation modes may be provided in the WLAN system according to an embodiment of the present invention.

TABLE 1

| PHY | MCS | Note |
|---|---|---|
| Control PHY | 0 | |
| Single carrier PHY | 1 . . . 12 | (low power SC PHY) |
| (SC PHY) | 25 . . . 31 | |
| OFDM PHY | 13 . . . 24 | |

Such modulation modes may be used to satisfy different requirements (e.g., high throughput or stability). Depending on the system, only some of these modes may be supported.

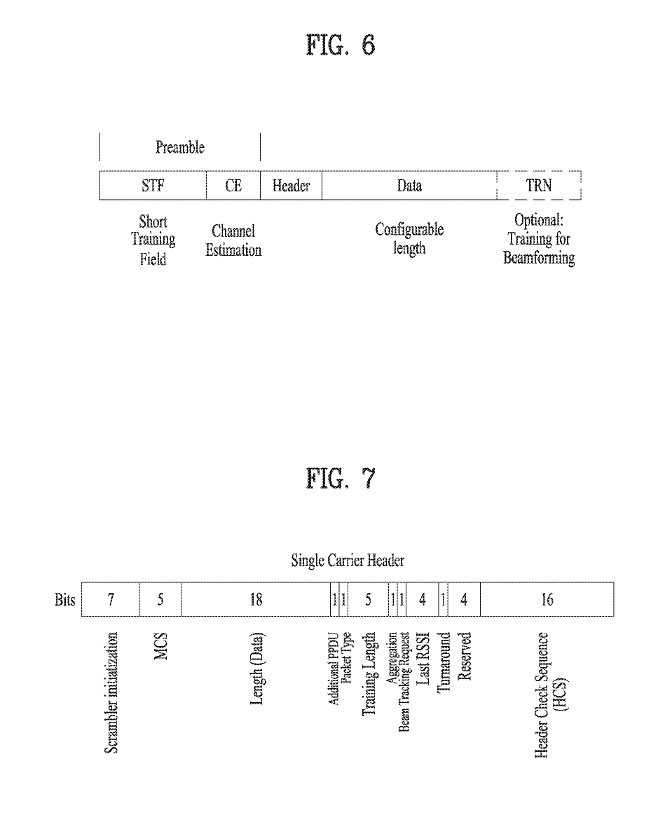

FIG. 6 is a diagram illustrating a physical configuration of an existing radio frame.

It is assumed that all the Directional Multi-Gigabit (DMG) physical layers include fields as shown in FIG. 6 in common. However, depending on the respective modes, physical layers may have a different method of defining individual fields and use a different modulation/coding scheme.

As shown in FIG. 6, the preamble of a radio frame may include a Short Training Field (STF) and Channel Estimation (CE). In addition, the radio frame may include a header and a data field as payload, and selectively include a TRN (Training) field for beamforming.

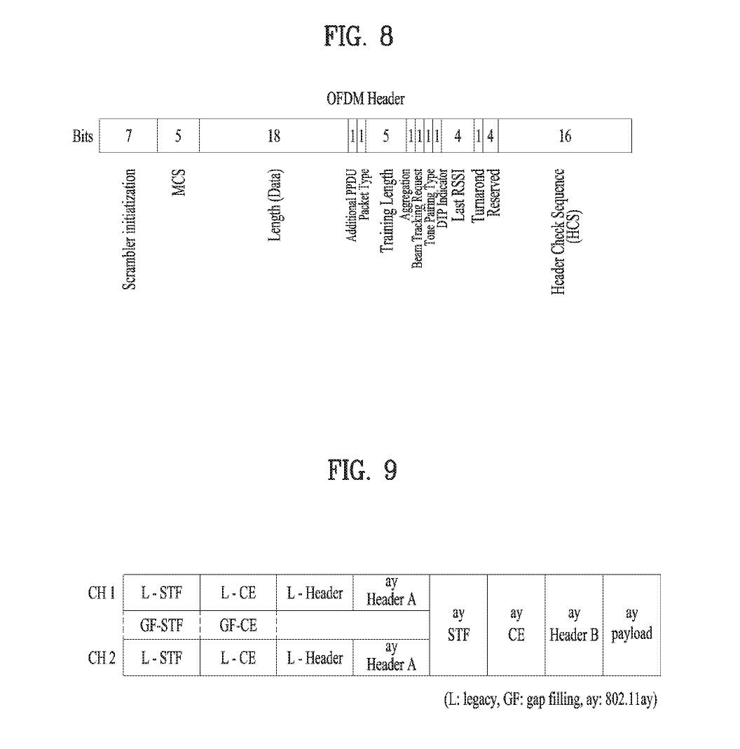

FIGS. 7 and 8 are diagrams illustrating configuration of the header field of the radio frame of FIG. 6.

Specifically, FIG. 7 illustrates a case where an Single Carrier (SC) mode is used. In the SC mode, the header may include information indicating an initial value of scrambling, a Modulation and Coding Scheme (MCS), information indicating the length of data, information indicating the presence or absence of an additional Physical Protocol Data Unit (PPDU), a packet type, a training length, an aggregation status, a beam tracking request status, a last Received Signal Strength Indicator (RSSI), a truncation status, and a Header Check Sequence (HCS). In addition, as shown in FIG. 7, the header has 4 reserved bits. The reserved bits may be utilized in the following description.

FIG. 8 specifically illustrates configuration of a header in a case where the OFDM mode is applied. The OFDM header may include information indicating an initial value of scrambling, an MCS, information indicating the length of data, information indicating the presence or absence of additional PPDU, a packet type, a training length, an aggregation status, a beam tracking request status, a last RSSI, a truncation status, and an HCS. In addition, as shown in FIG. 8, the header has 2 reserved bits. The reserved bits may be utilized in the following description as in the case of FIG. 7.

As described above, the IEEE 802.11ay system is considering introduction of channel bonding and MIMO technology in the legacy 11ad system for the first time. In order to implement channel bonding and MIMO in 11ay, a new PPDU structure is needed. In other words, the existing 11ad PPDU structure has limitations in supporting legacy UEs and implementing channel bonding and MIMO.

For this, a legacy preamble for supporting a legacy UE and a new field for a 11ay UE following a legacy header field may be defined, and channel bonding and MIMO may be supported through the newly defined field.

FIG. 9 is a diagram showing a PPDU structure according to a preferred embodiment of the present invention. In FIG. 9, the abscissa may correspond to the time domain, and the ordinate may correspond to the frequency domain.

When two or more channels are bonded, a frequency band (for example, a 400 MHz band) may exist between frequency bands (e.g., 1.83 GHz) used in the respective channels. In the mixed mode, a legacy preamble (legacy STF, legacy CE) is transmitted in duplicate through each channel. In an embodiment of the present invention, transmitting the new STF and CE field (gap filling) preamble through the 400 MHz band between the channels along with transmission of the legacy preamble may be considered.

In this case, as shown in FIG. 9, in the PPDU structure according to the present invention, ay STF, ay CE, ay header B, and payload are transmitted over broadband after a legacy preamble, a legacy header and an ay header A. Therefore, the ay header, ay Payload field, and the like to be transmitted after the header field may be transmitted through channels used for bonding. In order to distinguish the ay header from the legacy header, the ay header may be referred to as an enhanced directional multi-gigabit (EDMG) header, or “ay header” and “EDMG header” may be interchangeably used.

For example, a total of six channels (2.16 GHz) may be present in 11ay, and up to four channels may be bonded and transmitted to a single STA. Thus, the ay header and the ay payload may be transmitted over bandwidths of 2.16 GHz, 4.32 GHz, 6.48 GHz, and 8.64 GHz.

Alternatively, the PPDU format used when the legacy preamble is repeatedly transmitted without performing the gap-filling described above may also be considered.

In this case, the gap-filling is not performed, and thus the ay STF, ay CE, and ay header B are transmitted in a wideband after the legacy preamble, legacy header, and ay header A, without the GF-STF and GF-CE field indicated by the dotted line in FIG. 9.

2. Method for Transmitting PPDU According to the Present Invention

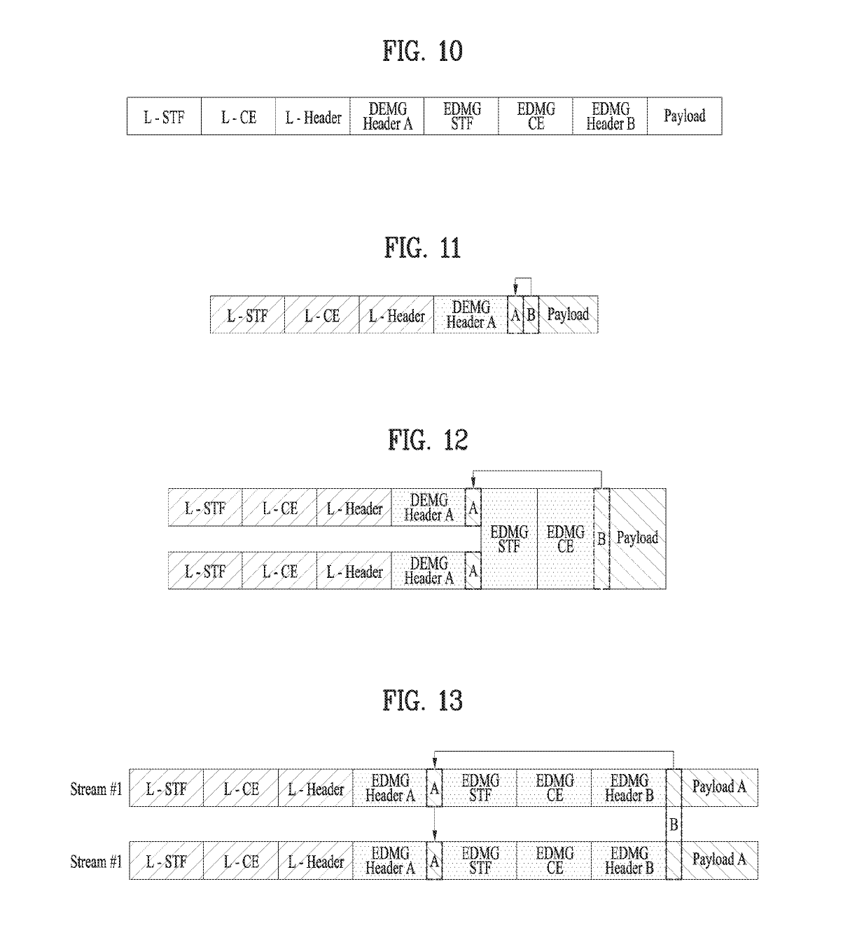

FIG. 10 is a diagram illustrating a PPDU structure applicable to the present invention.

As described above, a PPDU format of a frame structure as shown in FIG. 10 is considered in the 11ay system. In this case, a legacy part (L-STF, L-CE, L-Header) exists to allow a legacy STA (e.g., 11ad STA) as well as 11ay STA to decode the PPDU format.

On the contrary, in an EDMG part (EDMG Header A, EDMG STF, EDMG CE, EDMG Header B), only 11ay STA may decode the PPDU format. In this case, EDMG STF, EDMG CE, and EDMG Header B field may exist optionally. For example, the EDMG Header B field may exist when supporting Multi-User (MU). The EDMG Header B field may include information (e.g., specific information of each STA) different per STA.

Hereinafter, a method for transmitting the PPDU structure constructed as above will be described in detail. Although the present invention will be described based on a method for transmitting 11ay system based PPDU, the present invention may be applied to a method for transmitting a PPDU of another system. For example, the method for transmitting a PPDU as suggested in the present invention may be applied to 11ac, 11ax or various Wi-Fi systems suggested subsequently to the present invention.

2.1. Method for Encoding and Transmitting EDMG Header A Together with Some or all of PPDU Payload

2.1.1. Single Stream

FIG. 11 is a diagram illustrating a PPDU structure applicable to the present invention in case of non-channel bonding, and FIG. 12 is a diagram illustrating a PPDU structure applicable to the present invention in case of channel bonding. For convenience of description, the PPDU structure of FIG. 11 will be referred to as a non-channel bonding PPDU structure, and the PPDU structure of FIG. 12 will be referred to as a channel bonding PPDU structure.

The non-channel bonding PPDU structure of FIG. 11 may be the PPDU structure from which EDMG STF, EDMG CE, and EDMG Header B are omitted from the PPDU structure shown in FIG. 10. Also, the channel bonding PPDU structure of FIG. 12 may be the PPDU structure from which EDMG Header B is omitted from the PPDU structure shown in FIG. 10. In this case, the EDMG STF, and EDMG CE field may include information for channel configuration according to channel bonding.

In the present invention, a method for transmitting partial information of payload next to the EDMG Header A field by encoding and transmitting partial information of payload together with the EDMG Header A field to transmit the PPDU structure of FIGS. 11 and 12 will be suggested. At this time, various encoding methods may be used for encoding, and for example, a low density parity check (LDPC) encoding method may be used.

As shown in FIGS. 11 and 12, information (hereinafter, information A) encoded with the EDMG Header A field in the information included in payload may be encoded together with the EDMG Header A field and transmitted next to the EDMG Header A field. At this time, in the information included in the payload, information, which is not encoded together with the EDMG Header B field, is shown as information B to be identified from the information A.

In this case, a modulation and coding scheme (MCS) of the EDMG Header A field may be fixed to a specific value, or may be set variably. If the MCS is set variably, the L-Header field may include MCS information on the EDMG Header A field. In other words, STA that transmits the PPDU may signal the MCS information on the EDMG Header A field through the L-Header field.

At this time, if the MCS of the EDGMA Header A field is high, much information may be included in an encoding unit allocated to the EDMG Header A field or one or more symbols included in the encoding unit. Therefore, one encoding unit for encoding the EDMG Header A field may include another information as well as the information included in the EDMG Header A field. Therefore, in the present invention, a method for encoding the EDMG Header A field and partial information (information A) of the payload in one encoding unit and transmitting the encoded result will be suggested.

Therefore, the STA according to the present invention encodes the EDMG Header A field and the information A of the payload in one encoding unit and transmits the encoded result. An STA that has received the PPDU format transmitted in response to the above STA decodes the EDMG Header A field and the information A together. At this time, if a length of the payload is small to be included in the encoding unit allocated to the EDMG Header A field, the payload may be transmitted by being fully encoded together with the EDMG Header A field. In response to this, the STA that has received the PPDU format may decode the EDMG Header A field and the payload together.

If the EDMG Header A field and the information A corresponding to a part of the payload are encoded together in one example applicable to the present invention, common information may be applied to the information A. Hereinafter, information that may be included in the information A is as follows.

(1) MAC Header Information

For example, the information A may include BSS color (information indicating whether a specific BSS is a related BSS) and/or TXOP duration information. At this time, the MAC information included in the payload may be included in the information A only, or may be included in both the information A and the information B.

Particularly, if the MAC information included in the payload is included in both the information A and the information B, the MAC information of the payload may be maintained in the information B, and bit information of x bit size for signaling the MAC information included in the information B may be included in the information A. At this time, the x bit size may be the same as or smaller than the size of the bit information included in the information B. If the x bit size is smaller than the size of the bit information included in the information B, granularity is set linearly or non-linearly and thus information thereof may be included in the information A.

(2) MAC Header Information and/or Data

Information corresponding to a data part as well as the MAC Header information corresponding to a front part of the payload may be included in the information A. For example, if the payload part is subjected to interleaving and a part of the interleaved payload is transmitted through the information A, some or all of the MAC Header information and data information may be transmitted by being included in the information A.

For another example, some or all of the data information excluding the MAC Header information of the payload may be transmitted by being included in the information A.

(3) Multicast or Broadcast Information

Information (broadcast information) to be transmitted to all STAs or information (multicast information) to be transmitted to STA of a specific group may be included in the information A. For example, the information A may include information such as emergency status or disaster status.

If some or all of the information included in the payload is included in the information A and transmitted by being encoded together with the EDMG Header A field, bits of the last y bit size of the information A may be allocated as cyclic redundancy check (CRC) bits for the information A to allow the STAs to previously know the information included in the information A. Therefore, the STA that has received the information A encoded together with the EDMG Header A field may perform CRC check for the information A separately from the EDMG Header A field and receive the information A.

Also, if the CRC bits are not included in the information A, error check for the information A may be performed using CRC for the payload, whereby the information A may be transmitted and received. Alternatively, the information A may be transmitted and received without CRC check.

For another example, the above information may be included in the EDMG Header A field. In more detail, one or more symbols may be used or a high order MCS may be used when the EMDG Header A field is configured, whereby the aforementioned information may be included in the EDMG Header A field. At this time, TXOP duration (MAC duration), BSS color (BBS address), STBC, etc. may be included in the EDMG Header A field.

For still another example, specific information for the 11ay STA may be included in the information A regardless of the payload. At this time, the information A may be transmitted by being encoded together with the EDMG Header A field. The aforementioned components included in the CRC may equally be applied to this case.

2.1.2 Multi Streams

FIG. 13 is a diagram illustrating a PPDU structure applicable to the present invention in case of multi-stream transmission.

The PPDU structure shown in FIG. 13 may include payloads different per stream. At this time, each stream may be transmitted by channel bonding.

In more detail, all configurations of the above-described single stream may be applied to each stream.

At this time, since the information A is transmitted prior to the EDMG CE field or decoded prior to the EDMG CE field, the same information may be included in the information A per stream. For example, the information A may include a TA (Timing Advance) value.

Additionally, the EDMG Header A field may signal an STA for which the information A is intended, as follows.

For example, in case of MU, the EDMG Header A field may include bit information indicating that the information A is intended for a corresponding one of a plurality of STAs.

Also, in case of SU(Single-User), the EDMG Header A field may include bit information indicating that the information A is payload information (some or all) included in a corresponding one of a plurality of streams.

For another example, the information A may include information for a specific STA or duplicate information of the information B of a specific stream. Alternatively, the information A may include specific information for the 11ay STA only.

Through this configuration, the partial information A of the payload may be transmitted prior to the other information B of the payload in the time domain. Particularly, in FIG. 12, the partial information A of the payload may be transmitted prior to the EDMG STF, EDMG CE field. In FIG. 13, the partial information A of the payload may be transmitted prior to the EDMG STF, EDMG CE, and EDMG Header B field.

2.2. Method for Encoding EDMG Header A Together with Dummy Information and Transmitting the Encoded Result

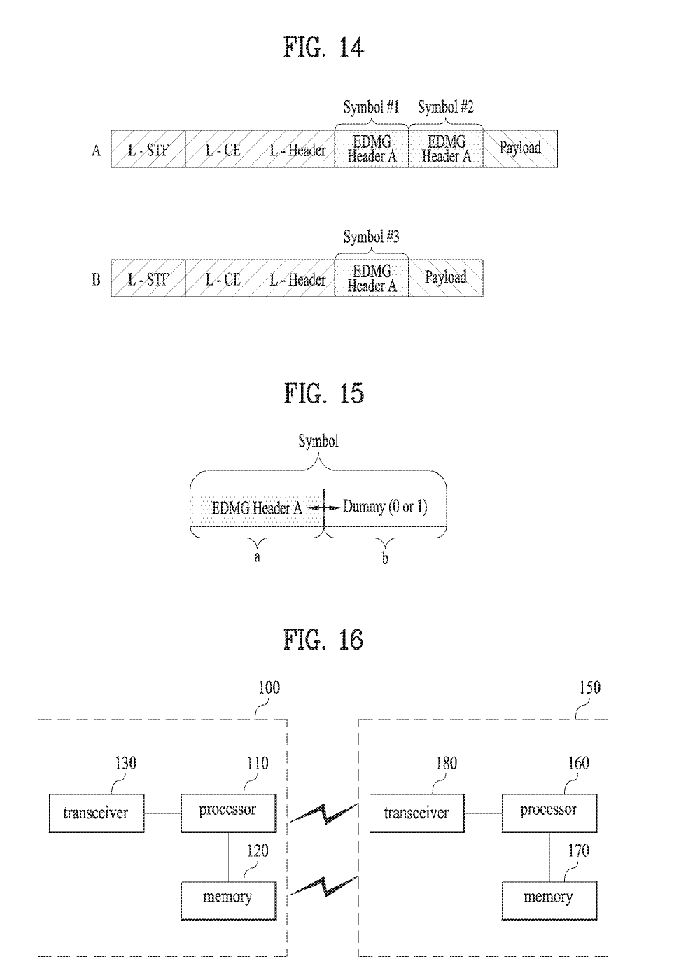

FIG. 14 is a diagram illustrating a PPDU structure applicable to the present invention.

As described above, the MCS which is previously determined may fixedly be applied to the EDMG Header A field, or may be applied variably in accordance with MCS information in the L-Header. At this time, as shown in FIG. 14, the EDMG Header A field may include two or more symbols like the PPDU format A, or may include one symbol like the PPDU format B. In case of the PPDU format A, a header check sequence (HCS) or CRC for the EDMG Header A field may be included in both of symbols #1 and #2, or may be included in symbol #2 only. At this time, if the HCS or CRC bits are included in the symbol #2 only, the EDMG Header A field may be encoded or decoded together with bits constituting the symbol #1.

FIG. 15 is a diagram illustrating a symbol #2 PPDU of a PPDU format A or a symbol #3 of a PPDU format B, which is shown in FIG. 14.

As shown in FIG. 15, information of the EDMG Header A of each symbol period is included in a part ‘a’, and a dummy value (0 or 1) which is a meaningless value is included in the other part ‘b’.

Therefore, bit information of the part ‘a’ corresponding to header information is only LDPC coded. That is, since the part ‘a’ corresponding to the header information within one encoding unit and the dummy value of the part ‘b’ , which is substantially meaningless, are encoded together, the bit information of the part ‘a’ corresponding to the header information is only encoded. At this time, the L-Header may signal LDPC coding size differently depending on the MCS of the EDMG Header A, or may apply only LDPC coding size which is previously determined. Sizes defined for payload transmission may be reused as the LDPC coding size, or the LDPC coding size may newly be defined for the EDMG Header A only.

In this way, the part ‘b’ is configured as a meaningless value, whereby UEs may obtain the time required for processing. In more detail, the UEs may decode the part ‘b’ and prepare a heavy operation, which will be performed later.

As information that may be included in the EDMG Header A, the same method as that described in 2.1 may be applied.

3. Device Configuration

FIG. 16 is a diagram illustrating devices for implementing the above-described method.

The wireless device 100 of FIG. 16 may correspond to a specific STA of the above description, and the wireless device 150 may correspond to the PCP/AP of the above description.

The STA 100 may include a processor 110, a memory 120 and a transceiver 130. The PCP/AP 150 may include a processor 160, a memory 170, and a transceiver 180. The transceivers 130 and 180 may transmit/receive wireless signals and may be implemented in a physical layer such as IEEE 802.11/3GPP. The processors 110 and 160 are implemented in the physical layer and/or MAC layer and are connected to the transceivers 130 and 180. The processors 110 and 160 may perform the UL MU scheduling procedure described above.

The processors 110 and 160 and/or the transceivers 130 and 180 may include application specific integrated circuits (ASICs), other chipsets, logic circuits, and/or data processors. The memories 120 and 170 may include a read-only memory (ROM), a random access memory (RAM), a flash memory, a memory card, a storage medium and/or other storage units. When an embodiment is executed by software, the method described above may be executed as a module (e.g., a process, a function) that performs the functions described above. The module may be stored in the memory 120,170 and executed by the processor 110,160. The memory 120, 170 may be located inside or outside the processor 110, 160 and may be connected to the processor 110, 160 by a well-known means.

The detailed description of preferred embodiments of the invention set forth above is provided to enable those skilled in the art to implement and practice the invention. Although the present invention has been fully described by way of example with reference to the accompanying drawings, it is to be understood that various modifications and changes may be made in the invention without departing from the scope and spirit of the invention. Accordingly, the present invention is not intended to be limited to the embodiments disclosed herein but is to be accorded the widest scope consistent with the principles and novel features disclosed herein.

### INDUSTRIAL APPLICABILITY

Although the present invention has been described on the assumption of the IEEE 802.11 based WLAN system, the present invention is not limited to this system. The present invention may equally be applied to various wireless systems that enable data transmission based on channel bonding.

What is claimed is:

1. A method for transmitting a physical protocol data unit (PPDU) from a station (STA) in a wireless LAN (WLAN) system, the method comprising
encoding first payload information included in a payload together with enhanced directional multi-gigabit (EDMG) header information in one encoding unit; and
transmitting a PPDU that includes the EDMG header information and the first payload information, which are encoded together.

2. The method according to claim 1, wherein the first payload information is a part of the payload.

3. The method according to claim 1, wherein the first payload and EDMG header information is encoded by a low density parity check (LDPC) encoding method.

4. The method according to claim 1, wherein the first payload information comprises one or more of physical access control (MAC) header information on the payload, MAC header information and data information on the payload, multicast information, and broadcast information.

5. The method according to claim 1, wherein the first payload information includes cyclic redundancy check (CRC) bits.

6. The method according to claim 1, wherein, when the PPDU is transmitted in multi-streams, first payload information per steam is identical.

7. A method for receiving a physical protocol data unit (PPDU) in a station (STA) in a wireless LAN (WLAN) system, the method comprising:
receiving a PPDU in which first payload information included in a payload is encoded together with enhanced directional multi-gigabit (EDMG) header information in one encoding unit; and
decoding the EDMG header information and the first payload information together, which are encoded.

8. The method according to claim 7, wherein the first payload information is a part of the payload.

9. The method according to claim 7, wherein the first payload and EDMG header information is encoded by a low density parity check (LDPC) encoding method.

10. The method according to claim 7, wherein the first payload information comprises one or more of physical access control (MAC) header information on the payload, MAC header information and data information on the payload, multicast information, and broadcast information.

11. The method according to claim 7, wherein the first payload information includes cyclic redundancy check (CRC) bits.

12. The method according to claim 7, wherein, when the PPDU is transmitted in multi-streams, first payload information per stram is identical.

13. A station operated in a WLAN system, the station comprising:
a transceiver having one or more radio frequency (RF) chains, configured to transmit and receive a signal to and from another station; and
a processor connected with the transceiver, processing the signal transmitted and received by the transceiver,
wherein the processor is configured to encode first payload information included in a payload together with enhanced directional multi-gigabit (EDMG) header information in one encoding unit and transmit a PPDU that includes the EDMG header information and the first payload information, which are encoded together.

14. A station operated in a WLAN system, the station comprising:
a transceiver having one or more radio frequency (RF) chains, configured to transmit and receive a signal to and from another station; and
a processor connected with the transceiver, processing the signal transmitted and received by the transceiver,
wherein the processor is configured to receive a PPDU in which first payload information included in a payload is encoded together with enhanced directional multi-gigabit (EDMG) header information in one encoding unit and decode the EDMG header information and the first payload information together, which are encoded.
